(19) United States
(12) Patent Application Publication
(10) Pub. No.: US 2010/0258686 A1
(43) Pub. Date: Oct. 14, 2010

(54) CABLE RACEWAY

(75) Inventors: David Alistair Sutton, Bristol (GB); Colin John West, Bristol (GB)

Correspondence Address: LOWE HAUPTMAN HAM & BERNER, LLP, 1700 DIAGONAL ROAD, SUITE 300, ALEXANDRIA, VA, 22314, US

(73) Assignee: AIRBUS OPERATIONS LIMITED, Bristol (GB)

(21) Appl. No.: 12/750,819

(22) Filed: Mar. 31, 2010

(30) Foreign Application Priority Data
Apr. 8, 2009 (GB) 0906071.6

(51) Int. Cl. F16L 3/015

(52) U.S. Cl. 248/73

(57) ABSTRACT

A cable raceway comprising: a base; a pair of side walls extending from the base to define the edges of a cable channel; three or more legs extending from the base; and a flange at a distal end of each leg for attaching the leg to a support structure. The base, side walls, legs and flanges are formed from an elastomeric material. The base contains reinforcement which extends along the length of the raceway and is embedded within the elastomeric material.

### FIELD OF THE INVENTION

The present invention relates to a cable raceway, and a cable raceway installation with such a raceway attached to a support structure. Typically, although not exclusively, the raceway is for use on a vehicle such as an aircraft.

### BACKGROUND OF THE INVENTION

Metallic cable raceways are typically used to guide cables along aircraft wings. However, when the wing bends during service, frictional forces between the metallic raceways and the cables can cause cable wear and damage. Moreover, metallic components add significant weight to the design, whilst they are also inflexible and subject to corrosion. Conventionally such raceways are bolted to the aircraft structure, either directly or via metal brackets.

EP-A-1168554 and US6648497 describe cable trays formed from non-metallic materials such as elastomer or acrylonitrile butadiene styrene (ABS). However a problem with these cable trays is that they are not suitable for use on a vehicle such as an aircraft, or any other application in which the raceway may be subjected to vibration, since such vibration could cause the cables to become damaged and/or dislodged from the tray. Also, vibration of the vehicle could cause the cable tray to hit an adjacent structure, causing damage to the structure.

### SUMMARY OF THE INVENTION

A first aspect of the invention provides a cable raceway comprising: a base; a pair of side walls extending from the base to define the edges of a cable channel; three or more legs extending from the base; and a flange at a distal end of each leg for attaching the leg to a support structure, wherein the base, side walls, legs and flanges are formed from an elastomeric material, and wherein the base contains reinforcement which extends along the length of the raceway and is embedded within the elastomeric material.

The side walls of the cable raceway also preferably contain reinforcement which extends along the length of the raceway and is embedded within the elastomeric material.

Preferably, the reinforcement is electrically conductive.

Typically the base, side walls, legs and flanges are formed together as a single piece, for instance by moulding.

The reinforcement may comprise a continuous reinforcement element, such as a strip or mesh, which is contained within the base and extends along the length of the raceway. In this case the continuous reinforcement element may also extend into the side walls of the raceway. Alternatively, the base and/or side walls may be reinforced along their length by chopped strand fibres (such as glass, ceramic or Kevlar ™) dispersed within the elastomeric material.

Preferably, the cable channel has a relatively wide interior for housing one or more cables and a relatively narrow neck for retaining the cable(s) within the interior.

The cable raceway may have a cover with a foam strip which is received in the cable channel. Such a cover may be attached to the raceway using a snap and click locking mechanism. The cable raceway may also have a foam seat inside the cable channel.

A second aspect of the invention provides a cable raceway installation comprising a cable raceway according to the first aspect of the invention with the flanges attached to a support structure, typically by adhesive and/or fasteners.

The cable raceway installation is typically provided on a vehicle such as an aircraft.

### BRIEF DESCRIPTION OF THE DRAWINGS

Embodiments of the invention will now be described with reference to the accompanying drawings, in which:

FIG. 1 is a sectional view of an elastomeric cable raceway where the length of the raceway extends perpendicular to the view shown;

FIG. 2 is a sectional view of an elastomeric raceway which is similar to that of FIG. 1 but also has flanges which project from the walls of the raceway channels;

FIG. 3 is a sectional view of an elastomeric raceway and a clip which can be attached to the raceway to secure cables in their respective channels;

FIG. 4 is a similar sectional view to FIG. 3 showing the clip attached to the raceway;

FIG. 5a is a plan view showing the ends of two adjacent raceway segments;

FIG. 5b shows a dovetail joint between the raceway segments;

FIG. 6 shows a raceway T-section;

FIG. 7a is a perspective view of an alternative raceway with each channel having separate conductive reinforcement elements;

FIG. 7b is a schematic diagram showing one of the separate conductive reinforcement elements of FIG. 7a being used as an electrical return path;

FIG. 8 is a perspective view of a similar raceway to that shown in FIG. 7a but with flanges that extend from the side walls of the cable channels;

FIG. 9 is a similar view to that shown in FIG. 8 but where the flanges in each channel are offset from each other.

FIG. 10 is an underside view of a section of elastomeric cable raceway according to a further embodiment of the present invention;

FIG. 11 is a side view of the raceway section shown in FIG. 10;

FIG. 12 is cross-sectional view taken along a line A-A in FIG. 10, showing the raceway attached to an aircraft structure;

FIG. 13 is a plan view of a bellows section of the raceway;

FIG. 14 is a side view of the bellows section; and

FIG. 15 is a sectional view showing one of the securing loops before it has been pushed through the base to form a loop over the cable.

### DETAILED DESCRIPTION OF EMBODIMENT(S)

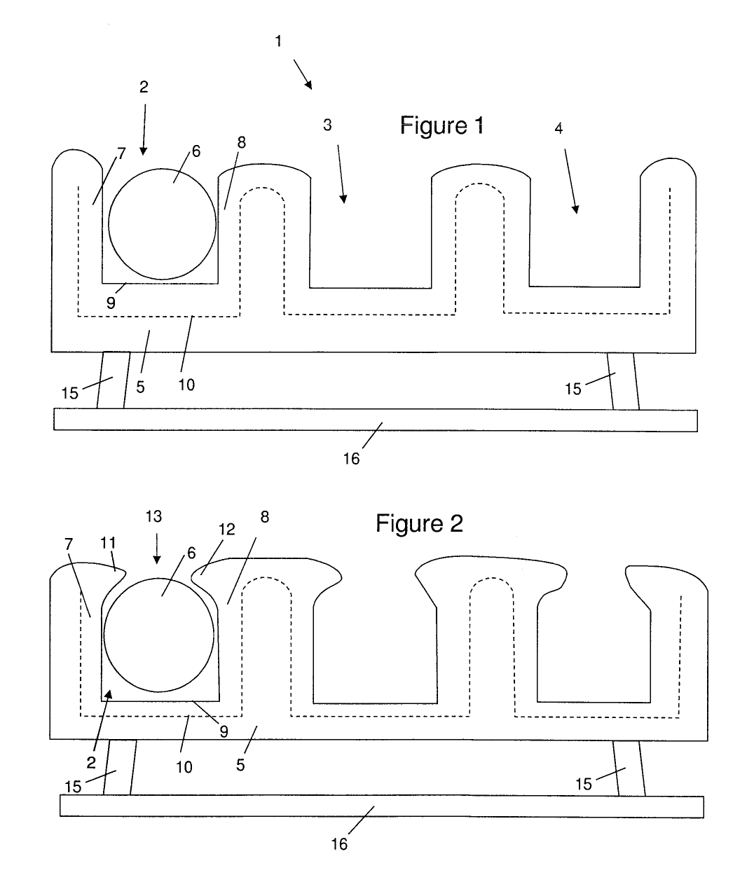

FIG. 1 shows, in cross section transverse to its length, a cable raceway 1 with three cable channels 2-4 for guiding cables along an aircraft wing (not shown). The raceway has a series of pairs of legs 15 which are spaced along its length for attaching the raceway to the wing structure. FIG. 1, being a cross-sectional view, shows only one pair of such legs 15. Each pair of legs 15 is joined together by a respective foot strip 16 which is bonded to the wing structure (not shown) with an adhesive.

The cable channels 2-4 are similar and so only channel 2 will be described in detail. Cable channel 2 consists of a base 5, which supports a cable 6 (or a bundle of cables), and a pair of side walls 7, 8 which extend from the base 5 to define the edges of the channel 2. The cable 6 rests on a floor 9 of the channel and is held in place along the length of the raceway with, for example, fairlead assemblies or routing clips as described in patent application US2008134477. The base 5, side walls 7, 8, legs 15 and foot strips 16 are made from an elastomeric material, such as fluorosilicone rubber or polyurethane. If the raceway is made from a material other than polyuerethane, then a polyurethane scrim may be applied to the underside of the foot strips 16 in order to enhance the adhesive bond.

The base 5 and sidewalls 7,8 contain an electrically conductive reinforcement element 10, such as a brass strip, wire mesh or carbon nanotube fabric which extends along the length of the raceway (the length running perpendicularly to the section view of FIG. 2). The reinforcement element 10 provides an electrical return path along the raceway for the signals carried by the cable 6. Additionally, the reinforcement element 10 increases the longitudinal stiffness of the raceway so that it tends not to stretch lengthwise when the aircraft performs a high-G turn during flight. This is important as any deformation of the raceway, particularly lengthwise stretching, could result in breakage of the cables routed within the channels 2-4.

In FIG. 1, the electrically conductive reinforcement element 10 is formed as a single continuous piece. However, separate reinforcement elements may alternatively be installed in the side walls 7, 8 and/or in the base 5 to provide separate electrical return paths for the cables in each channel 2-4 (see below). A single continuous conductive reinforcement element is easier to manufacture, but several separate conductive reinforcement elements provide additional flexibility in the routing of electrical signals.

The base 5, side walls 7, 8, legs 15 and foot strips 16 are formed together as a single piece by compression or transfer moulding or by a multi-stage process involving composite inserts.

The legs 15 splay outwardly relative to each other as they extend from the base 5. This provides a more stable platform than if the legs 15 extended at 90 degrees to the base 5. Preferably, each leg extends from the base at an angle of less than 80 degrees, and more preferably, less than 70 degrees.

Preferably the foot strips 16 each join together a pair of legs 15. This provides a robust structure particularly before the raceway is installed. However, optionally a central part of one or more of the foot strips 16 can be cut away if clearance is required for some part of the aircraft structure.

The legs 15 are formed from elastomeric material which is inherently flexible and resilient. This enables the legs 15 to act as vibration dampers, damping vibration that would otherwise be transmitted from the aircraft structure to the raceway. The hardness, length, diameter and angle of the legs 15 can be selected to damp frequencies within an expected range. For example if the aircraft is propeller-driven then the dominant mode of vibration will have a frequency of the order of 400 Hz and the legs 15 can be designed so that they damp vibration at that frequency.

FIG. 2 shows, in cross section, an alternative cable raceway 1a which has a number of features in common with the cable raceway 1 shown in FIG. 1. The same reference numerals will be used for identical features. As before, as the channels 2-4 are similar, only channel 2 will be described in detail. In this case, channel 2 has a pair of flanges 11, 12 which are integrally formed with the side walls 7, 8. These flanges may extend along the length of the raceway, or may extend along only part of its length. The flanges 11, 12 project from the side walls 7, 8 to form a narrow neck 13 in the channel 2. As the cable 6 is pushed down through the neck and into the channel 2, the flanges 11, 12 are compressed, and the side walls 7, 8 are bent to the side to widen the neck 13 sufficiently for the cable 6 to be inserted into the relatively wide interior of the channel 2. Once the cable 6 has been inserted, the flanges and the side walls 7, 8 spring back to their original positions to retain the cable 6 in the channel 2. The flanges act as an assembly aid by holding the cables in place before they are clamped more securely to the base of the raceway with, for example, fairlead assemblies or routing clips as described in patent application US2008134477. As the flanges help to restrain the cables in the channels 2-4, the distance along the length of the raceway between successive fairlead assemblies or routing clips can be increased. This reduces part count and reduces the chance of damage to the cables by the fairlead assemblies or routing clips.

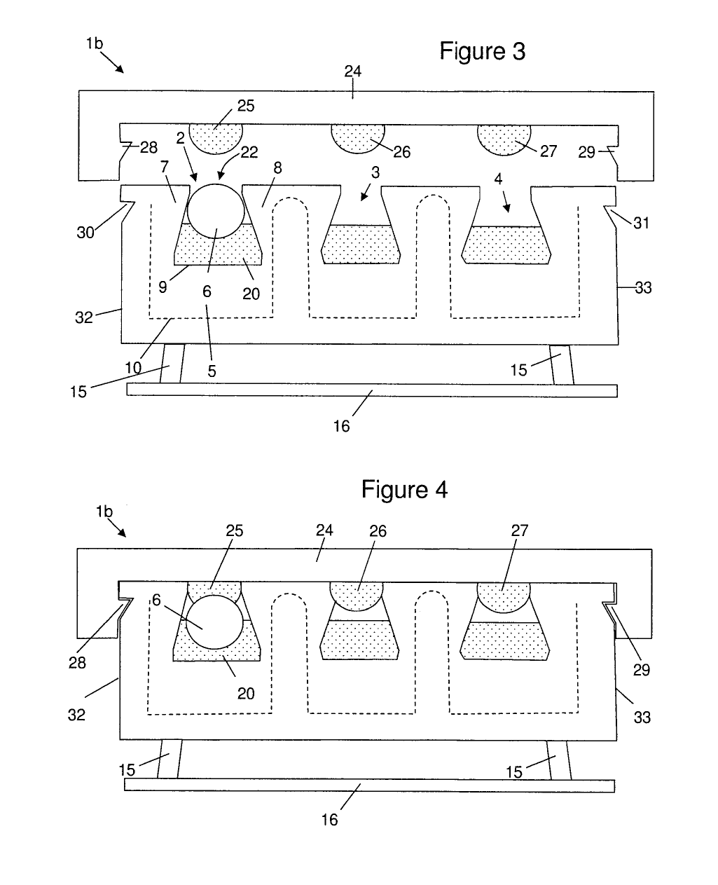

FIGS. 3 and 4 illustrate an alternative cable raceway 1b which is similar to the raceways 1, 1a shown in FIGS. 1 and 2. Identical features will be given the same reference numerals. As before, channels 2-4 are similar and only channel 2 will be described in detail. In this case, the floor 9 of the channel 2 carries a series of foam seats 20 on which the cable 6 rests. The foam seats 20 are spaced apart along the length of the channel so only one seat is shown in FIG. 3.

The side walls 7, 8 increase in thickness as they extend upwards from the base 5, converging towards each other to form a relatively narrow neck 22 in the channel 2. As the cable 6 is pushed down into the channel 2, the side walls 7, 8 bend to the side to widen the neck 22 sufficiently for the cable to be inserted into the relatively wide interior of the channel 2. Once the cable 6 has been inserted, the side walls 7, 8 spring back to their original positions to help restrain movement of the cable 6 in the channel 2.

The converging side walls, in a similar way to the flanges described with respect to FIG. 2, act as an assembly aid by holding the cable 6 in the channel 2 before it can be clamped to the base of the raceway more securely. As with the flanges in FIG. 2, the converging side walls also allow the distance between fairlead assemblies or routing clips to be increased compared to the arrangement shown in FIG. 1. These converging side walls may extend along the length of the raceway, or may extend along only part of its length.

After the cable 6 has been inserted into the channel 2, a series of routing clips 24 is attached to the top of the raceway 1b to hold the cable 6 in place. The clips 24 are spaced apart along the length of the channel so only one clip 24 is shown in FIG. 3. Each clip 24 is positioned above a respective row of foam seats 20.

Each clip 24, which may be formed from an elastomer or a harder plastic such as PEEK or Nylon, is C-shaped in cross section, having two similar side arms extending as shown in FIGS. 3 and 4. Three foam pads 25-27, which are aligned with the channels 2-4 of the raceway, project from the underside of the clip 24. The clip 24 also has a “snap and click” locking mechanism consisting of a pair of teeth 28, 29 which project from the inner surfaces of the side arms of the clip 24. The raceway has a corresponding pair of recesses 30, 31 in its outer side walls 32, 33, as shown most clearly in FIG. 3. When the clip 24 is pressed down on the raceway, the side arms of the clip are bent to the side until the teeth 28, 29 snap back into the recesses 30, 31 in the raceway as shown in FIG. 4. Meanwhile, the foam pads 25-27 are compressed as they pass through the necks of the channels 2-4. As shown in FIG. 4, the foam pad 25 is also compressed against the cable 6, pushing the cable 6 down into the foam seat 20 and securing it in place.

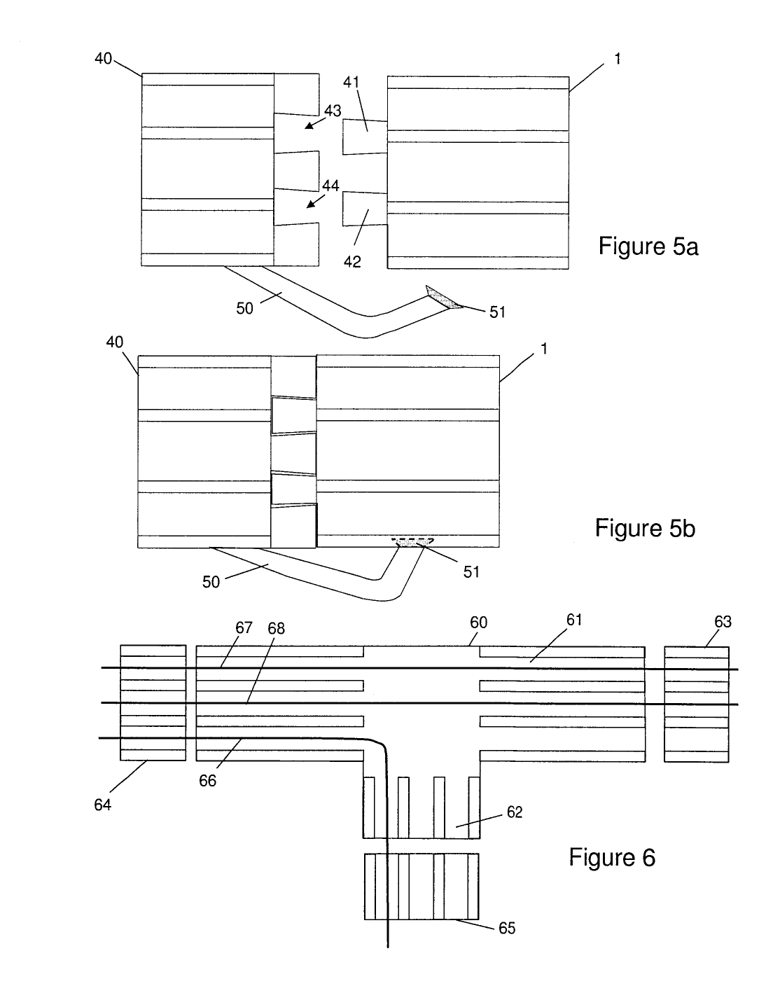

FIG. 5a shows one end of the raceway 1, and the end of an adjacent raceway 40. The base of the raceway 1 is formed with a pair of trapezoidal pins 41, 42 which can be pushed into a corresponding pair of trapezoidal tails 43, 44 to form a dovetail joint as shown in FIG. 5b.

A bonding lead 50 is permanently attached to the reinforcement element in the raceway 40. The bonding lead 50 has a plug 51 which is received in a socket (not shown) in the side of the raceway 1 and makes contact with the reinforcement element 10 in the raceway 1. Where a single electrical return path is provided by a single continuous conductive reinforcement element 10, only one bonding lead 50 is required. However, if several separate electrically conductive reinforcement elements are provided within the raceway segments, one bonding lead will be required per conductive pathway.

FIG. 6 is a plan view of a raceway T-section 60 which consists of a main raceway path 61 and a secondary raceway path 62 which extends at right angles from the main raceway path 61 halfway along its length. The T-section 60 allows cables to be re-routed from the main raceway path 61 to the secondary raceway path 62. Straight raceway segments 63-65 can be connected to either side of the main raceway path and to the secondary raceway path 62 to guide cables to and from the T-section 60. In the example of FIG. 6, cable 66 is re-routed to the secondary path 62 whilst cables 67, 68 pass through the T-section 60 on the main raceway path 61.

For purposes of clarity the joints between the T-section 60 and the raceway segments 63-65 are not shown, but preferably these are dovetail joints as shown in FIG. 5b.

The underside of the T-section 60 has vibration damping legs 15 and flanges 16 in common with the raceway 1 of FIG. 1, but these are not visible in FIG. 6 which is a plan view.

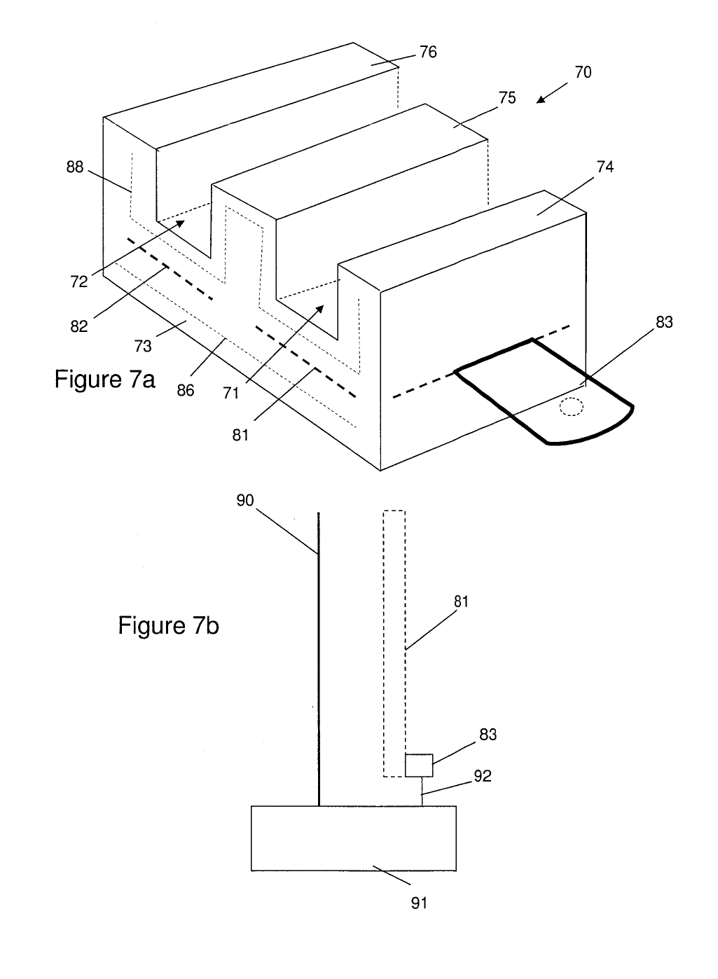

FIG. 7a is a perspective view of an alternative cable raceway 70 with two cable channels 71, 72 defined by a base 73 and three side walls 74-76. The base 73 and the side walls 74-76 are made from an elastomeric material, such as fluorosilicone rubber or polyurethane

Separate conductive reinforcement strips 81, 82 extend along the length of the base 73 underneath the channels 71 and 72 respectively to provide separate electrical return paths for each channel. Note that there is a gap between the conductive reinforcement strips 81, 82 and that they do not extend into the side walls of the channels 71, 72. The strips 81, 82 are formed from a woven carbon nanotube fabric, or from copper mesh. At each end of the raceway, a metal tab 83 is connected to the strip 81 and extends to one side of the raceway. A bonding lead can then join together an adjacent pair of tabs 83, in order to form an electrical joint between an adjacent pair of raceways.

Alternatively the tab 83 can be used as shown schematically in FIG. 7b. FIG. 7b shows an electrical assembly comprising a cable 90 housed in a raceway channel (not shown) and connected to an electrical component 91 such as a light or a control surface actuator. The component 91 is electrically connected in turn to the strip 81 via a connector 92 and the tab 83. Thus the strip 81 provides an electrical return path, or electrical ground, for the component. A second pair of conductive tabs (not shown) provides electrical access to the other conductive strip 82.

In addition to the conductive strips 81, 82, a first non-conductive glass-fibre woven mesh reinforcement element 86 extends across the width of the base 73 and along its length. A second non-conductive glass-fibre woven mesh reinforcement element 88 is folded into the side walls 74-76 and also extends along the length of the raceway.

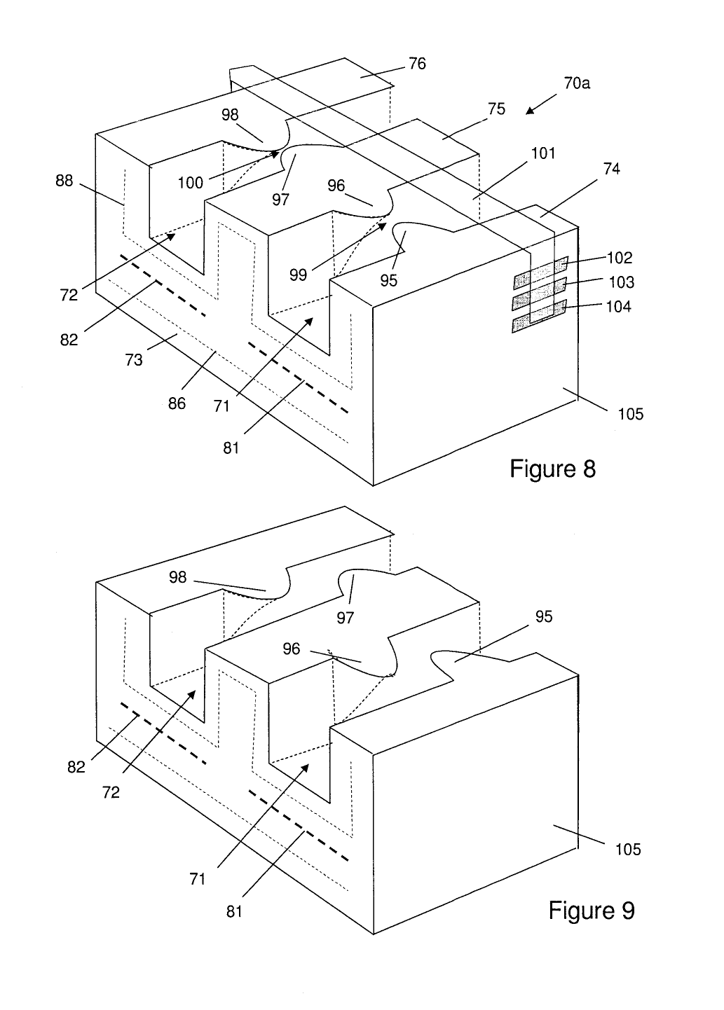

FIG. 8 shows a similar raceway 70a to the raceway 70 shown in FIG. 7 with the conductive tab 83 omitted. The same reference numerals will be given to equivalent features. In this case, each channel 71, 72 has a pair of flanges 95, 96 and 97, 98 which are integrally formed with the side walls 74-76. The flanges 95-98 extend from the side walls to form narrow necks 99, 100 in each of the channels 71, 72. The flanges 95-98 extend along only part of the length of the channels and so a number of pairs of flanges are provided along the length of each channel. Cables can be inserted into the channels in a similar way to that described with respect to FIG. 2 above.

A set of clips 101 (one of which is shown in FIG. 8) are attached across the width of the raceway. Clips 101 are similar to clips 24 described in FIGS. 3, 4. However, as indicated in FIG. 8 by the three recesses 102-104 on the outer wall 105 of the raceway, three snap and click locking mechanisms are provided as a failsafe in case one of the locking mechanisms fails to function correctly. It is understood that any number of recesses could be provided.

As an alternative to the arrangement shown in FIG. 8, the flanges 95, 96 and 97, 98 may be offset from each other along the length of the channels 71, 72. This is illustrated in FIG. 9. As above, a number of pairs of flanges are included along the length of each channel. When cables (not shown) are inserted into the channels 71, 72, they are wound around successive flanges and the interaction between the flanges and the cables holds the cables in place before they are clamped more securely to the base of the raceway as described above.

The raceways shown in FIGS. 7a-9 have vibration damping support legs, similar to the raceway 1, but these are not shown in the Figures.

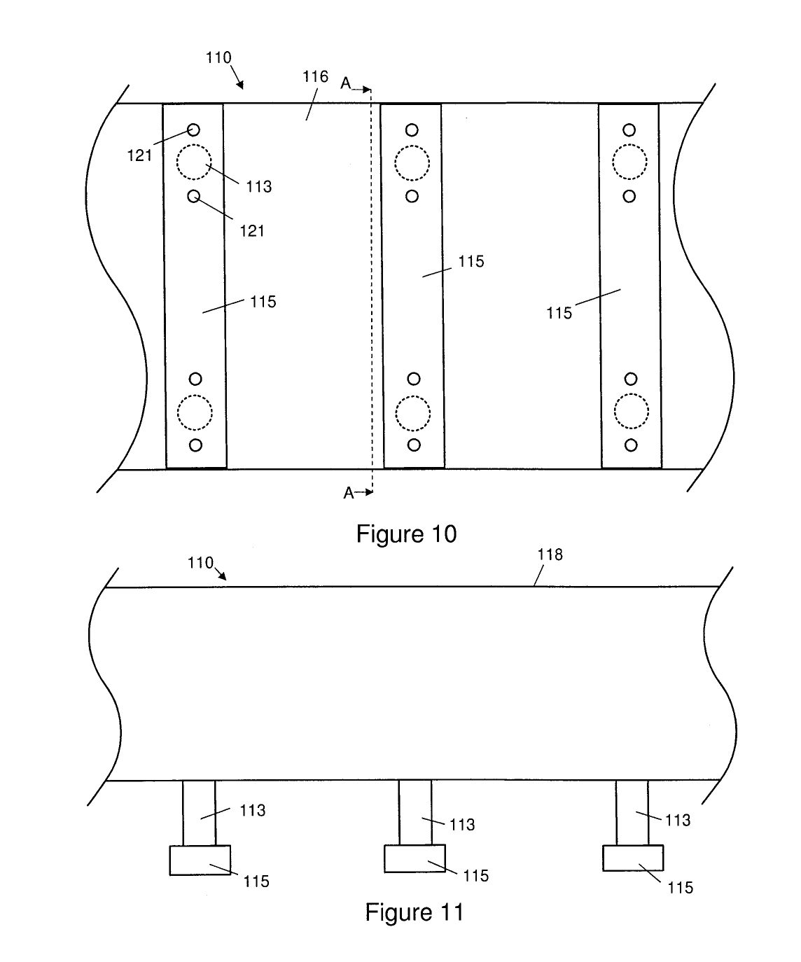

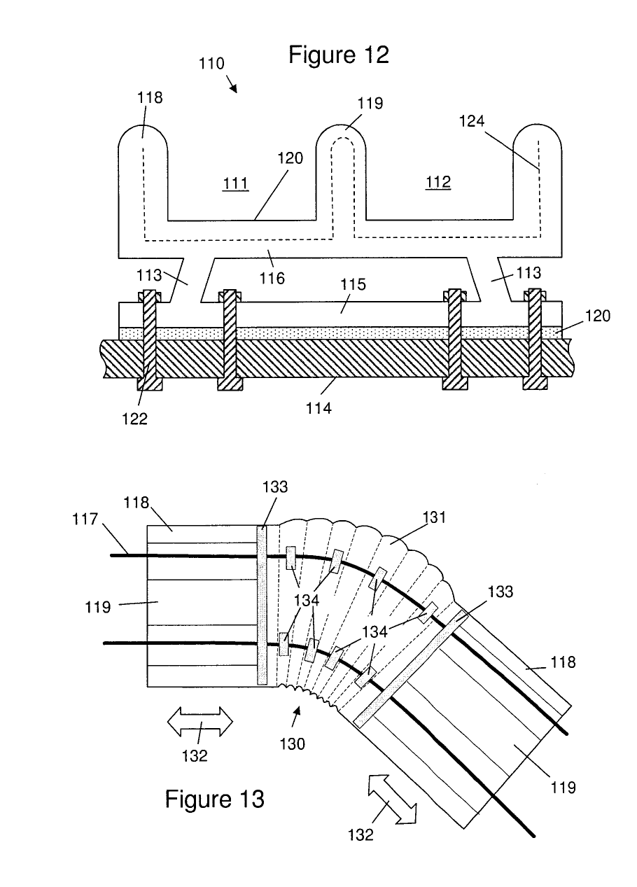

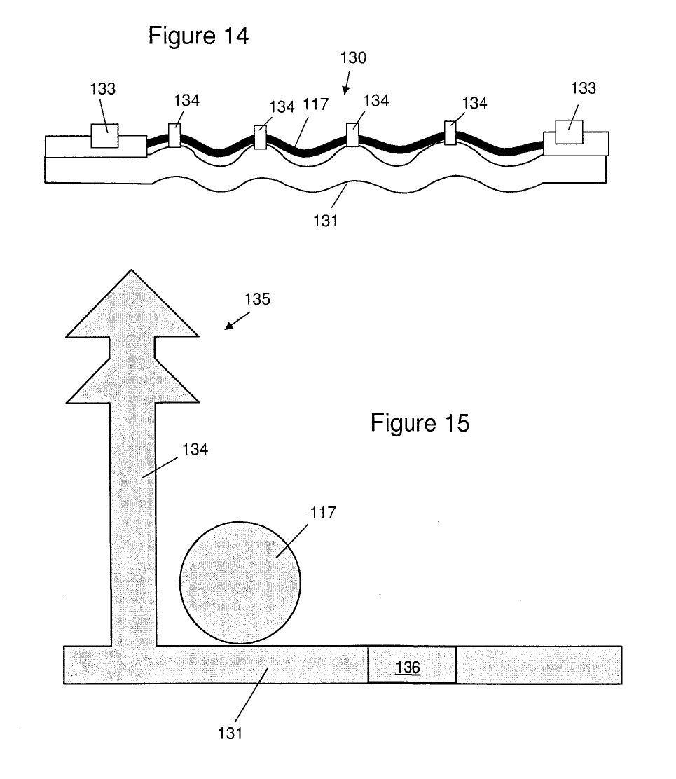

FIGS. 10-15 show a cable raceway 110 with two cable channels 111, 112 for guiding cables along an aircraft wing (not shown). The raceway has a series of pairs of legs 113 which are spaced along its length for attaching the raceway to a wing structure 114 as shown in FIG. 12. FIG. 12, being a cross-sectional view, shows only one pair of such legs 113. Each pair of legs 113 is joined together by a respective foot strip 115 which is bonded to the wing structure 114 with an adhesive 120. The cable channels 111, 112 are similar and so only channel 111 will be described in detail. Cable channel 111 consists of a base 116, which supports a cable 117 (not shown in FIG. 12 but shown in FIG. 13) and a pair of side walls 118, 119 which extend from the base 116 to define the edges of the channel 111. The cable 117 rests on a floor 120 of the channel and is held in place along the length of the raceway with, for example, fairlead assemblies or routing clips as described in patent application US2008134477. The base 116, side walls 118, 119, legs 113 and foot strips 115 are made from an elastomeric material, such as fluorosilicone rubber or polyurethane. The raceway also contains an electrically conductive reinforcement element 124.

The legs 113 splay outwardly relative to each other as they extend from the base 116. This provides a more stable platform than if the legs 113 extended vertically down from the base 116. Preferably, each leg extends from the base at an angle of less than 80 degrees, and more preferably, less than 70 degrees.

As well as being bonded to the structure 114, the foot strips 115 have fastener holes 121 which enable them to be fixed to the structure by fasteners 122, such as a nuts and bolts, as shown in FIG. 12.

Optionally a central part of the foot strip 115 can be cut away if clearance is required for some part of the aircraft structure.

The legs 113 are formed from elastomeric material. Because elastomeric material is inherently flexible and resilient, it enables the legs to act as vibration dampers, damping vibration that would otherwise be transmitted from the aircraft structure to the raceway. The hardness, length, diameter and angle of the legs can be selected to damp frequencies within an expected range.

The support structure 114 may be in any orientation relative to the raceway: for instance it may be positioned below the raceway as shown in the figures with the support structure oriented horizontally, or it may be positioned on one side of the raceway with the support structure oriented vertically.

FIGS. 10-12 show a straight section of the raceway 110. Where the raceway is required to bend, then a bellows joint section 130 with a corrugated base 131 can be built into the raceway 110 at an intermediate position along its length as shown in FIG. 13-15. The side walls 118, 119 terminate where they meet the bellows joint section, making it easier for the raceway to flex to form a bend as shown in FIG. 13, as well as permitting the adjacent lengths of raceway to move back and forth as indicated by arrows 132 in FIG. 13. Clips 133 secure the cable at either end of the bellows section and securing loops 134 guide the cable around the angle of the joint.

Each clip 133 is fitted to the raceway in a similar manner to the clip 23 (FIG. 3) or the clip 101 (FIG. 8). The loops 134 are integrally moulded with the raceway, and each loop has a barbed head 135 as shown in FIG. 15 which is pushed through a hole 136 in the base 131 to form a loop over the cable 117.

There are a number of benefits in making the raceway from elastomeric materials when compared to existing metallic designs, particularly when the raceway is to be used on an aircraft wing. These can be summarised as follows:
the elastomeric external surface is non-conductive, providing a layer of electrical insulation between the cables and the conductive reinforcement element, while the conductive reinforcement element provides a selective conductive path through the raceway.
elastomeric materials such as fluorosilicone rubber and polyurethane are of lower density than the metals which are typically used in cable raceways, leading to potential weight savings
ability to bond the raceway directly on to the wing structure—e.g. the raceway could be co-cured with a composite structure or it could be bonded to the wing structure with adhesive
no corrosion or galvanic compatibility issues
ability to manufacture elastomeric raceway as a moulded part
elastomeric raceways are semi-flexible which allows movement in response to wing bending, reducing cable wear
ability to connect segments of raceway together using a dovetail or “snap and click” attachment system, minimising the number of tools required.

Although the invention has been described above with reference to one or more preferred embodiments, it will be appreciated that various changes or modifications may be made without departing from the scope of the invention as defined in the appended claims.

1. A cable raceway comprising: a base; a pair of side walls extending from the base to define the edges of a cable channel; three or more legs extending from the base; and a flange at a distal end of each leg for attaching the leg to a support structure, wherein the base, side walls, legs and flanges are formed from an elastomeric material, and wherein the base contains reinforcement which extends along the length of the raceway and is embedded within the elastomeric material.

2. The cable raceway of claim 1 wherein the legs comprise two or more pairs of legs spaced apart along the length of the raceway, each leg in a pair being arranged on an opposite side of the raceway to the other leg and splaying outwardly relative to the other leg.

3. The cable raceway of claim 1 wherein the reinforcement is electrically conductive.

4. The cable raceway of claim 1 wherein the reinforcement comprises a continuous reinforcement element which is contained within the base and extends along the length of the raceway.

5. The cable raceway of claim 1 wherein the side walls contain reinforcement which extends along the length of the raceway and is embedded within the elastomeric material.

6. The cable raceway of claim 5 wherein the reinforcement comprises a continuous reinforcement element which is contained within the base and side walls and extends along the length of the raceway.

7. The cable raceway of claim 1 wherein the cable channel has a relatively wide interior for housing one or more cables; and a relatively narrow neck for retaining the cable(s) within the interior.

8. The cable raceway of claim 1 wherein the base, side walls, legs and flanges are formed together as a single piece.

9. The cable raceway of claim 1 further comprising a foam seat inside the cable channel.

10. The cable raceway of claim 1 further comprising a cover having a foam strip which is received in the cable channel.

11. The cable raceway of claim 1 wherein the base has a corrugated section at an intermediate position along its length, the corrugated section of the base having no side walls.

12. The cable raceway of claim 1 wherein the flanges have fastener holes.

13. The cable raceway of claim 1 wherein the legs comprise two or more pairs of legs spaced apart along the length of the raceway, and wherein the flanges comprise strips which each join together a pair of legs.

14. A cable raceway installation comprising the cable raceway of claim 1 with the flanges attached to a support structure.

15. A vehicle comprising the cable raceway installation of claim 14.
